(19) United States
(12) Patent Application Publication
(10) Pub. No.: US 2008/0072943 A1
(43) Pub. Date: Mar. 27, 2008

(54) Crutch

(76) Inventor: Deborah Anne Forster, York (GB)

Correspondence Address: JACOBSON HOLMAN PLLC, 400 SEVENTH STREET N.W., SUITE 600, WASHINGTON, DC, 20004, US

(21) Appl. No.: 11/596,193

(22) PCT Filed: May 10, 2005
(86) PCT No.: PCT/GB05/01751

§ 371 Date: Nov. 27, 2007

(30) Foreign Application Priority Data
May 11, 2004 (GB) 0410554.0

(51) Int. Cl. A61H 3/02

(52) U.S. Cl. 135/71

(57) ABSTRACT

A cuff portion for a forearm crutch, and a forearm crutch incorporating such a cuff portion are described. The forearm crutch consists of a lower elongate and generally straight part, an upper elongate generally straight part connected to and in particular angled relative to the lower elongate part, a handle part for gripping by a patient for example at or about the said angle, and a cuff portion connected to the end of the upper straight part. The cuff portion is modified by provision of a stabilising arm (4, 5) connected to the cuff (2) and outwardly extendable relative to the cuff so as to be moveable between a retracted position close to the side of the cuff and an extended position outwardly from the side of the cuff so as to define in combination with the cuff a base on which the crutch can be stood in an upright position.

The present invention relates to a walking aid or crutch, and more particularly to a crutch for invalids of the kind known as a forearm or elbow crutch and having a cuff.

Such crutches consist of a lower elongate and usually straight portion for contacting the ground, a handle part for gripping by the patient, and an upper elongate-and usually straight part lying at an angle, typically of 10-15°, to the lower part and including a cuff for engaging the patient's arm at or about the elbow. The distance between the handle part and the cuff is approximately equal to the length of the patient's forearm. At least the lower elongate straight portion and preferably also the upper is often of telescopic construction so that the crutch is adaptable for use by patients of different heights. For example, each elongate portion might comprise two telescoping parts, and include a fixing mechanism operating to fix these two parts in a number of relative positions corresponding to a number of different lengths.

Modern crutches are made from tubular light weight material such as aluminium alloy. In the case of such a construction, the elongate straight portions may be made of telescopic construction in that they comprise at least two tubular parts nested together. Means to fix a telescoping adjustable portion at variable predetermined lengths are provided, for example comprising suitable combinations of projections and apertures. In particular, each such tube is provided with a succession of apertures, these apertures are aligned between nested tubular parts, and at least one fixing pin is inserted therethrough to fix the elongate straight portion to the desired length.

To make these crutches fully adaptable for use by any patient the cuff may be pivotable about its connection to the upper-straight part, thus allowing the cuff to adopt a comfortable position about the patient's arm.

A problem frequently experienced by users is that the crutches are unstable when left alone in an upright position and tend to fall over even when rested in an upright position against the side of a table, chair or the like. This is a serious problem for users because, by reason of the injury or disability which necessitates their use of a crutch, they may have difficulty reaching down to pick it up.

Various solutions have been suggested to the problem of allowing a crutch to stand upright on the ground when not in use. In particular, since it is not generally desirable for a crutch user to carry around a separate stand means, modifications have been proposed to crutch design to give this additional functionality.

For example, secondary stand members have been incorporated into the lower part of the lower portion of the crutch, as illustrated for example in European published patent applications EP1136054 and EP1106161. The additional mechanisms involved impose additional complexity onto the crutch, and are likely to impose additional costs, and in many instances, be impractical. Any solution should be kept as simple as possible, and make as much use as possible of existing components.

It is an object of the present invention to provide a crutch which can be stood upright on the ground when not in use.

According to a first aspect of the present invention there is provided an upper cuff portion for a forearm crutch of the type comprising a lower elongate and generally straight part, a handle part for gripping by the patient, an upper elongate and generally straight part, and a cuff located towards and for example situated at or connected to, the end of the upper straight part It comprises a cuff having a stabilising arm connected to the cuff and outwardly extendable relative to the cuff.

The stabilising arm is moveable between a retracted position in which it lies close to the side of the cuff so as not to impede normal usage of the crutch and an extended position in which it extends outwardly from the side of the cuff so as to define in combination with the cuff a base on which the crutch can be stood in an upright position. Preferably the inner side of the stabilising arm is profiled to match the outer side of the portion of the cuff against which it seats so that it forms a close fit therewith in the retracted position.

In a typical preferred arrangement of cuff, as will be familiar, the cuff comprises a pair of cuff arms, for example in the form of generally arcuate arm portions, extending outwardly from a mid point corresponding to the longitudinal axis of the upper elongate part and for example from the upper elongate part. These are so arranged as in use to partially surround and support a user's aim in the vicinity of the elbow. In a preferred embodiment of the invention the cuff has such a configuration, and a stabilising arm as hereinbefore described is provided in association with each such cuff arm.

In accordance with the invention, the crutch is stabilised for standing upright on the ground when not in use upside down (relative to its in use orientation). Ground contact is made by the uppermost, in use, end of the crutch, and a stabilising platform is provided by the cuff and stabilising arm(s).

In a conventional forearm or elbow crutch, attempting to use the cuff as a stand is of little practical use. The angle between the upper and elongate part and lower elongate part, and the relative lengths of the two parts, mean that if the crutch is stood upside down with the upper elongate part generally vertical it will not be stable. Even if the pivoting connection between the upper elongate part and the cuff is made use of in an attempt to counteract this, the resulting arrangement is still relatively lacking in stability. Any additional support conferred by the cuff is disposed entirely to one side of the end of the upper elongate part and the crutch is still readily overbalanced.

The provision of at least one additional stabilising arm in accordance with the present invention which can be deployed away from the side of the cuff provides a further degree of stability. The resultant “stand” covers a greater area, and is not limited to extending in merely one direction away from the centre axis of the upper elongate straight portion. In particular, in the preferred embodiment where the cuff comprises paired arms each provided with its own deployable stabilising arm, stabilising arms can be deployed to give a multi-point support disposed generally radially around the upper straight part.

The resultant arrangement is a much more stable stand which nevertheless makes use of and gives a second functionality to the cuff itself, and thus limits the degree of modification necessary to existing crutch design, and limits the complexity and cost of any modification.

Preferably, the stabilising arm is connected to the side of the cuff by a hinge which permits it to be pivoted between the retracted and extended positions. Conveniently, the hinge is self-closing so that it tends to default to the retracted position whereat the stabilising arm is held close to the side of the cuff. Various designs of self-closing hinge are well known within the art which are suitable for use in the present invention. Examples, include toggle over centre hinges, top dead centre hinges, cam operated hinges and spring biased hinges.

Conveniently the stabilising arm and hinge are cast as a single piece of plastic material and may be cast in the open position. The combined stabilising arm and hinge may further comprises a stud or shaped projection which is releasably engaged within a slotted groove formed on the side of the cuff. This arrangement allows the combined stabilising arm and hinge to be easily removed from the cuff and replaced if it becomes broken or worn. Alternatively the entire cuff may comprise a replacement unit.

In a preferred embodiment of the present invention the hinge comprises a pair of hinge straps which are flexible or elastic over their length and a cam member which is rigidly fixed and engageable with one of the two hinge straps at a point along its length. The hinge provides a toggle action about the cam between stable open and closed states.

In accordance with the invention in its broadest aspect, a cuff portion is described for a forearm crutch including at least one stabilising arm as above described. In use, the cuff portion comprises a portion, and especially an uppermost, in use portion of an upper elongate part of a forearm crutch which may otherwise be of generally conventional design. To that end, a cuff in accordance with the first aspect of the invention may be formed integrally with and as a part of the uppermost portion of the upper straight part or may be provided separably from and adapted for connection thereto. In particular for example a cuff in accordance with the invention may be provided as an accessory for and/after market modification to a conventional forearm crutch having a conventional cuff.

In a common embodiment of forearm crutch the upper elongate part may be provided in two or more pieces being relatively adjustable, for example being slidingly adjustable and most preferably having a telescoping adjustment, to adjust the length of the upper elongate part for different users. For use with such a crutch as a detachable accessory, the cuff portion in a preferred embodiment is further provided with an elongate extending portion so disposed in use as to serve as an uppermost component of such a multicomponent upper elongate part, and preferably being provided with suitable means to connect thereto, for example towards a distal end.

Preferably, the cuff and elongate extension arc connected via an articulating joint about which they can be pivoted so that with the crutch assembled the cuff is pivotable about its connection to the assembled upper elongate straight pall. For example, the cuff is enabled pivot from a plane generally perpendicular to the long axis of the extension of an angle of 15 to 20° therefrom.

According to a second aspect of the present invention there is provided a forearm crutch incorporating a cuff portion as hereinbefore described, that is to say a forearm crutch comprising a lower elongate and generally straight part, an upper elongate generally straight part in particular angled relative to the lower elongate and generally straight part, a handle part for gripping by a patient for example at or about the said angle, and a cuff located towards (and for example connected to) the end of the upper elongate part, wherein a stabilising an is connected to the cuff and is outwardly extendable relative to the cuff.

Preferably the cuff portion is enabled to pivot relative to the upper elongate part, for example from a plane generally perpendicular to the long axis of the upper part of an angle of 15 to 20°therefrom.

Each elongate part is preferably length-adjustable, in particular via a telescoping action. For example, each elongate part comprises a plurality of nested tubular members. A locking mechanism is preferably provided to selectively lock the elongate part at a desired length. For example, nested tubular members are provided with a plurality of apertures selectively engagable via suitable protrusions and/or suitable external pins.

In a particularly preferred embodiment, the upper elongate part comprises a plurality of such tubular members, the uppermost (in use) such tubular member being integrally formed with and as a downward elongate extension of the cuff portion. In particular, the cuff is hingedly connected thereto.

Preferably the cuff is connected to the upper elongate part when assembled via an articulating joint about which the cuff can pivot relative to the upper elongate part in the manner described above, for example from a perpendicular orientation to an angle of 15 to 20° therefrom.

For convenience, to indicate the relative positions of components on the crutch, reference is frequently made herein to upper/lower or uppermost/lowermost. Except as indicated to the contrary, or where the context so demands, this reference is to the positions of the components with the crutch in normal use. However, references are merely for convenience to indicate the relative positions of the elements of the crutch, and should not be construed as being further limiting.

An embodiment of the present invention will now be described, by way of example, with reference to the accompanying drawings, in which:

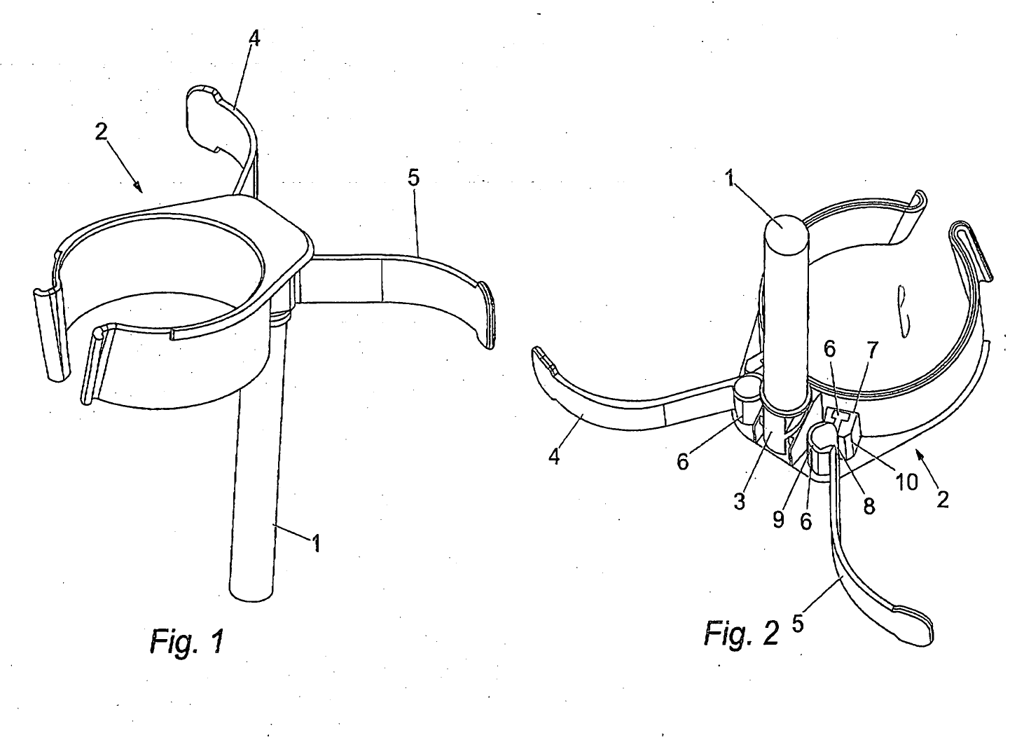

FIG. 1 is a view from above of the upper straight section of an elbow crutch according to the present invention with both stabilising arms in the extended position;

FIG. 2 is a view of the upper straight section of the elbow crutch shown in FIG. 1 turned upside down to illustrate how the extended stabilising arms could support a crutch in an upright position on the floor;

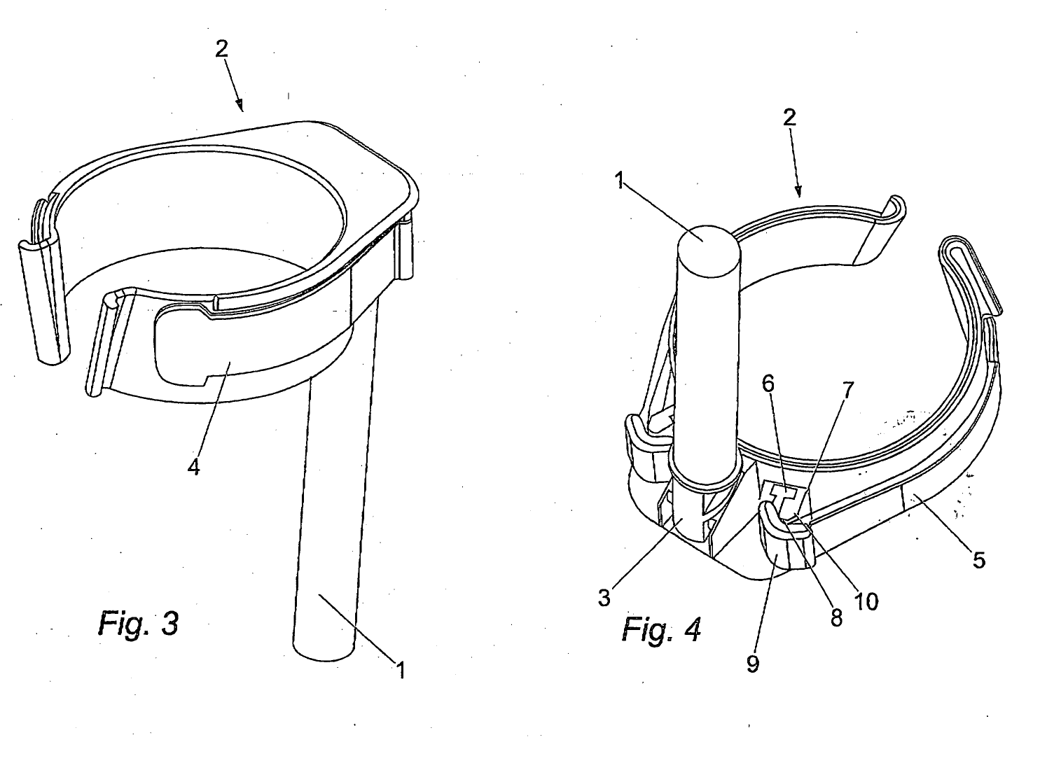

FIG. 3 is the same view as shown in FIG. 1 with the stabilising arms retracted; and

FIG. 4 is the same view as shown in FIG. 2 with the stabilising arms retracted.

Referring to the drawings there is shown the upper straight section of an elbow crutch. The lower straight section of the crutch which contacts the ground and which includes a hand grip has been omitted for ease of illustration, but is in all respects conventional in design. The upper straight section as shown comprising a length of aluminium tubing 1 and a plastic cuff 2. One end of the aluminium tubing 1 is received in a socket 3 in the, base of the cuff. The mounting between the socket 3 and the base of the cuff 2 allows the cuff 2 to pivot in a vertical plane to accommodate different users of the crutch, as is low with conventional crutches.

A stabilising ann 4, 5, each comprising an integral self closing plastic hinge mechanism 6, is connected to the base of the cuff 2, one on each side of the socket 3. Each stabilising arm 4, 5 is pivotable about the hinge mechanism 6 between stable open, that is to say extended as shown in FIGS. 1 and 2, are closed, that is to say retracted as shown in FIGS. 3 and 4, positions. In the closed position the arm 4, 5 lies closely against the outside surface of the side of the cuff 2 and to this end it profiled to match the side of the cuff. In this position it barely projects from the cuff and does not impede or prevent normal use of the crutch. In the open position the arms 4, 5 extend outwardly from the base of the cuff. Together the arms 4, 5 and the cuff 2 form a base on which the whole crutch can stand in an inverted upright position.

The connection between each stabilising arm 4, 5 and cuff 2 is form by a projection 6 of T-shaped section which is slidably received in a slot, also of T-shaped section, formed by an additional moulding 7 on the base of the cuff This sliding connection allows the stabilising aim 4, 5 to be easily detached from the cuff 2 if it is not required or if it should become necessary to replace it. The self-closing plastic binge mechanism 6 is formed by a pair of hinge straps 8 and 9 which are flexible or elastic over their length and a cam surface 10 formed by the moulding 7. The innermost of the two hinge straps 8 and 9 engages with the cam surface 10 to effect a toggle action at a point along its length. With a stabilising ann in the extended position the innermost of the two straps is resiliently biased outwardly, relative to the outermost strap, and braced against the cam surface 10 to retain the hinge in a stable open state. When the stabilising arm is retracted the innermost of the two straps is biased against the cam surface which causes the strap to invert. This in turn shortens the effective length of the strap and imparts a snap action to the hinge causing the arm to be closed.

It will be understood that a patient using a crutch in accordance with the present invention can place the clutch in the ground in the inverted upstanding position with the stabilising arms extended without fear of it falling over. This makes everyday use of the crutch easier and more convenient.

Existing crutches may readily be modified to incorporate the benefits of the present invention by replacing the existing cuff with a cuff featuring stabilising arms as described hereinbefore.

Conveniently, the crutch may be manufactured from a polymer mixed with iridescent or fluorescent material or it may be coated with such a material so that the crutch can be seen in the dark.

1. A cuff portion for a forearm crutch comprising a cuff having a stabilising arm connected to the cuff and outwardly extendible relative to the cuff between a retracted position in which it lies close to the side of the cuff and an extended position in which it extends outwardly from the side of the cuff so as to define in combination with the cuff a base on which the crutch can be stood.

2. A cuff portion in accordance with claim 1 wherein the inner side of the stabilising arm is profiled to match the outside of the portion of the cuff against which it seats so that it forms a close fit therewith in the retractable position.

3. A cuff portion in accordance with claim 1 wherein the cuff comprises a pair of cuff arms, and wherein a stabilising arm is provided connected to each cuff arm and outwardly extendible relative thereto.

4. A cuff portion in accordance with claim 3 wherein the cuff comprises a pair of generally arcuate arm portions extending outwardly from a mid-point, each provided with a stabilising arm having a corresponding arcuate form so as to form a close fit therewith in the retracted position.

5. A cuff portion in accordance with claim 1 wherein the stabilising arm is connected to the side of the cuff by a hinge which permits it to be pivoted between the retracted and extended positions.

6. A cuff portion in accordance with claim 5 wherein the hinge is self closing to the retracted position whereat the stabilising arm is held close to the side of the cuff.

7. A cuff portion in accordance with claim 5 wherein the hinge comprises a pair of hinge straps which are flexible or elastic or their length and a can member which is rigidly fixed and engagable with one of the two hinge straps at a point along its length.

8. A cuff portion in accordance with claim 1 provided separately from and adapted for connection to an upper elongate part of a forearm crutch.

9. A cuff portion in accordance with claim 8 wherein the cuff portion is further provided with an elongate extending portion so disposed in use as to serve as an uppermost component of a multicomponent upper elongate part of a forearm crutch.

10. A cuff portion in accordance with claim 9 wherein the cuff and elongate extending portion are connected via an articulating joint.

11. A forearm crutch comprising a longer elongate part, an upper elongate part, a handle part for gripping by a patient, and a cuff portion in accordance with claim 1 located towards the end of the upper elongate part.

12. A forearm crutch in accordance with claim 11 wherein each elongate part is of adjustable length via telescoping action.

13. A forearm crutch in accordance with claim 12 wherein each elongate part comprises a plurality of nested tubular members, the uppermost (in use) tubular member of the upper elongate part being integrally formed with and as a downward elongate extension of the cuff portion.

14. A forearm crutch in accordance with claim 11 wherein the cuff is connected to the upper elongate part via an articulating joint about which the cuff can pivot relative to the upper elongate part.
